(19) United States
(12) Patent Application Publication
(10) Pub. No.: US 2019/0051031 A1
(43) Pub. Date: Feb. 14, 2019

(54) SYSTEM AND RECORDING MEDIA THEREOF FOR USING AR TECHNOLOGY COMBINES HAND-CREATING ELEMENTS TO PRODUCING VIDEO WORKS

(71) Applicant: OVER PARADIGM TECHNOLOGY INC., Kaohsiung City (TW)

(72) Inventors: Pei-Wei CHYAU, Kaohsiung City (TW); Shih-Yun CHIU, Kaohsiung City (TW); Yu-Chun LIN, Kaohsiung City (TW)

(21) Appl. No.: 16/101,991

(22) Filed: Aug. 13, 2018

(30) Foreign Application Priority Data
Aug. 14, 2017 (TW) 106127421

(51) Int. Cl. G06T 11/60; G06T 19/00; G06F 3/01; G06T 13/40; G09B 5/06

(52) U.S. Cl. CPC G06T 11/60; G06T 19/006; G09B 5/065; G06T 13/40; G06F 3/017

(57) ABSTRACT

A system that combines augmented reality (AR) technology with self-created elements to produce video works and a media storing the same are revealed. The system includes a data module used for storing drawing templates and scenes, a video input module that reads a hand-drawn image of a picture book and defines a hand-drawn border, a recognition and analysis module that compares the drawing template with the hand-drawn border to get drawn content, a voice input module that reads a speech to generate voice content, and an integration module that integrates the drawn content, the voice content and the scene for generating a self-created AR work. Thereby users can use the system to create AR video works with self-created elements in a real-time manner.

### BACKGROUND OF THE INVENTION

Technical Field

The present invention relates to a system and recording media thereof for using AR (augmented reality) technology combines hand-creating elements to producing video works, especially to a s system for using AR technology combines hand-creating elements to producing video works and a recording medium thereof that are applied to games or teaching materials for children.

Description of Related Art

Owing to parental involvement in children's education, more and more computer-assisted instruction (CAI) programs have been developed to meet significantly growing market demands every year. According to the survey, computer has become one of the top three things parents want their children to learn, just behind language and music. In near future, learning software for kids plays a vital role in children's education, no matter viewed from the demand side or the supply side.

The augmented reality (AR) technology for education is going to be the technology of the future, not only changes the market rules but also have wide applications. The AR can connect the real word to visual images directly or indirectly. The smart phones connected to internet and the mobile devices provided with cameras contribute to the growth of AR.

Now there are interactive motion-sensing games and teaching materials produced by augmented reality (AR) technology available on the market. AR images are generated through learning flash cards and displayed in an interesting and interactive way to help children concentrate on their learning. Thus the teaching materials are both entertaining and educational. However, most of these AR materials are single-mode, such as pure voice/pattern recognition/scanning. Children are unable to create their own patterns or speeches and then integrate their works with AR images to create AR animations. Thus AR teaching materials have great potential in inspiring and conveying kids' creativity.

### SUMMARY OF THE INVENTION

Therefore it is a primary object of the present invention to provide a system and recording media thereof for using AR technology combines hand-creating elements to producing video works, which uses users' hand-creating elements to form AR video works in a real-time manner.

The present invention provides a system for using AR technology combines hand-creating elements to producing video works according to the present invention is executed in an electronic computer system and is composed of a data module used for storage of at least one drawing template and at least one scene, a video input module that reads a hand-drawn image corresponding to at least one 2D character of a picture book and defines a hand-drawn border of the hand-drawn image, a recognition and analysis module that generates drawn content by comparison of the drawing template with the hand-drawn border, and an integration module that fills the drawn content into the drawing template correspondingly for generating an AR object and integrates the AR object with the scene for generating a self-created AR work.

The present invention also provide a non-transitory computer-readable recording medium used for storing the system for using AR technology combines hand-creating elements to producing video works mentioned above.

Implementation of the present invention at least produces the following advantageous effects:

1. The self-created AR works containing hand-creating elements are created by users themselves.
2. The self-created AR works are produced in a real-time manner.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing an embodiment in use according to the present invention;

FIG. 2 is a block diagram showing structure of an embodiment according to the present invention;

FIG. 3 is a schematic drawing showing a picture book applied to an embodiment according to the present invention;

FIG. 4 is a schematic drawing showing a drawing template of an embodiment displayed on a computer screen according to the present invention;

FIG. 5A is a schematic drawing showing a hand-drawn image of a character of a picture book according to the present invention;

FIG. 5B is a schematic drawing showing drawn content created by a recognition and analysis module according to the present invention;

FIG. 6A is a schematic drawing showing a 2D character with recognition points of a picture book according to the present invention;

FIG. 6B is a schematic drawing showing an image generated from the embodiment in FIG. 6A according to the present invention;

FIG. 6C is a schematic drawing showing drawn content completed by recognition points of an embodiment according to the present invention;

FIG. 7 is a schematic drawing showing drawn content integrated with a drawing template of an embodiment according to the present invention;

FIG. 8 is a block diagram showing an embodiment integrated by HTML technology according to the present invention;

FIG. 9 is a block diagram showing structure of an embodiment further having an electronic book generating module according to the present invention.

### DETAILED DESCRIPTION OF THE INVENTION

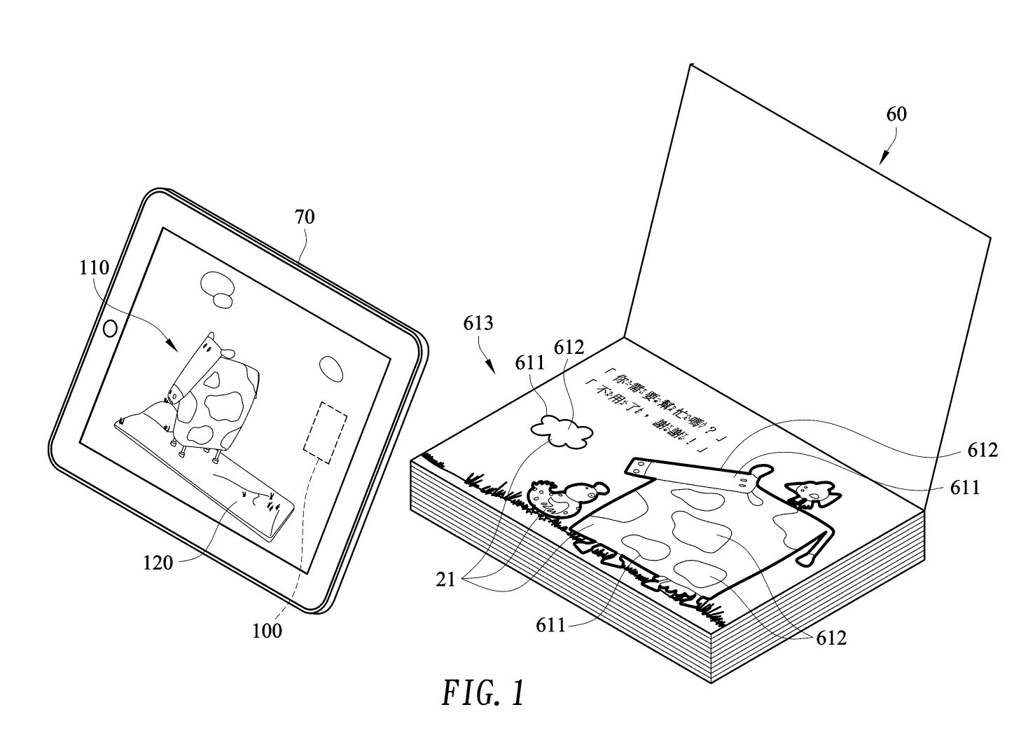

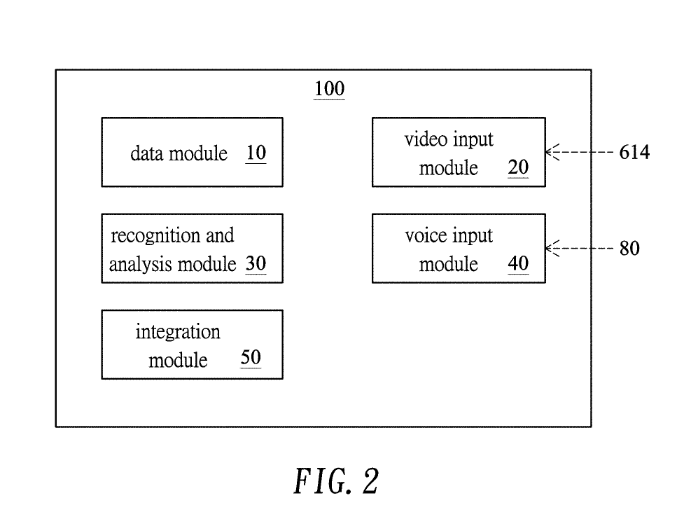

Refer to FIG. 1 and FIG. 2, a system for using AR (augmented reality) technology combines hand-creating elements to producing video works 100 according to the present invention includes a data module 10, a video input module 20, a recognition and analysis module 30, a voice input module 40, and an integration module 50. The system for using AR technology combines hand-creating elements to producing video works 100 can be a software system executed in an electronic computer system 70 such as a mobile phone, a personal digital assistance, a computer, etc. The video works produced can be 2-dimensional (2D) or 3-dimensional (3D).

While in use, besides the software used for executing the present system that produces video works 100, a teaching aid such as a picture book 60, a flash card, a jigsaw puzzle, etc. is also used. The picture book 60 can be an AR book formed by a plurality of contiguous pages.

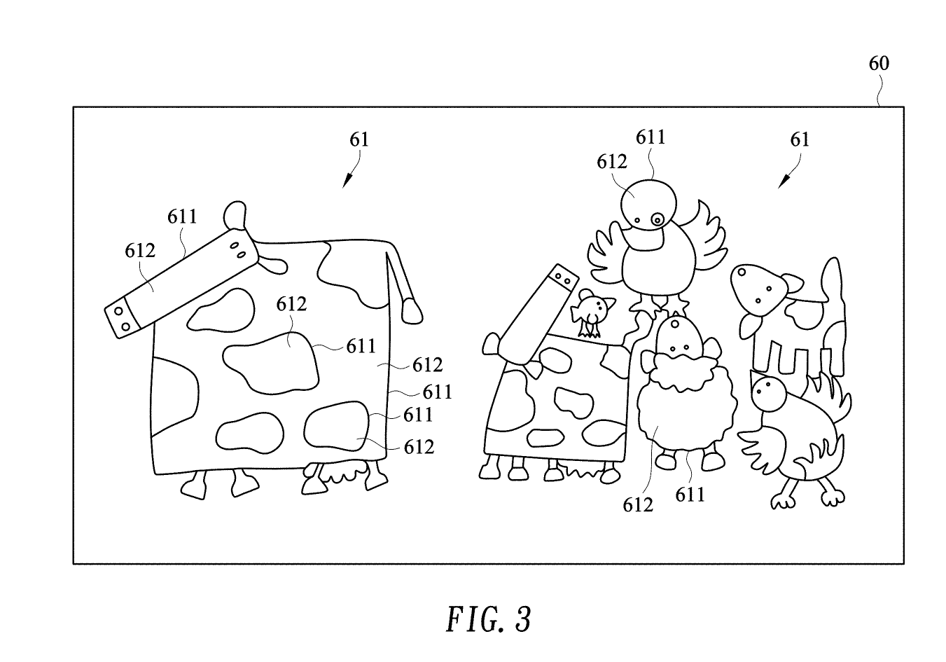

As shown in FIG. 1 and FIG. 3, each page of the picture book 60 is designed to include at least one flat 2D character 61 such as an animal, a person, a bird, etc. At least a part of these flat 2D characters 61 includes a border 611 and a creative area 612 is inside the border 611. Thereby kinds can create their own designs in the creative area 612 easily and conveniently by crayons.

Each page of the picture book 60 also has a 2D scene 613. The arrangement of the above 2D character 61 and the 2D scene 613 in the respective page or the whole picture book 60 forms a script of a story-unit or a story script.

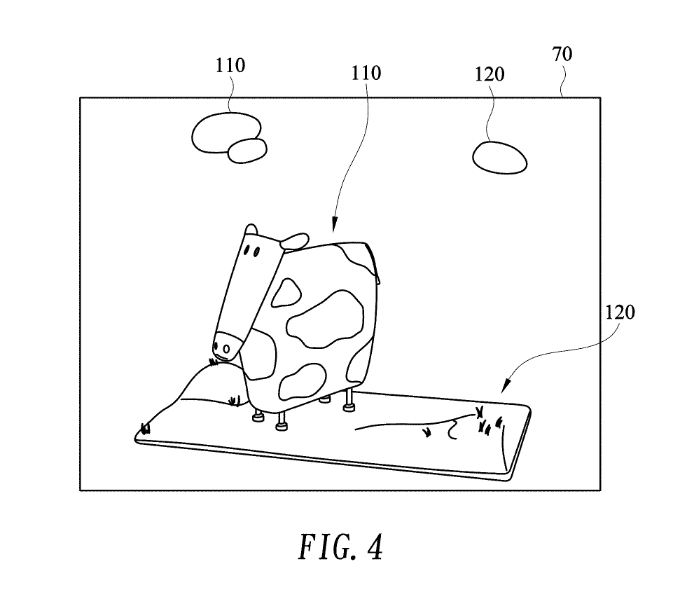

As shown in FIG. 2 and FIG. 4, the data module 10 is used to store at least one drawing template 110 and at least one 2D/3D scene 120. The drawing template 110 is a 2D/3D character or object represented only by lines. The 2D character 61 with the border 611 of the picture book 60 is processed by Augmented Reality (AR) technology to produce the drawing template 110. For coherence of the story, the 2D/3D scene 120 is generated based on the picture book 60. That means the flat 2D scene 613 of the picture book 60 is converted into the 2D/3D scene 120 by AR technology.

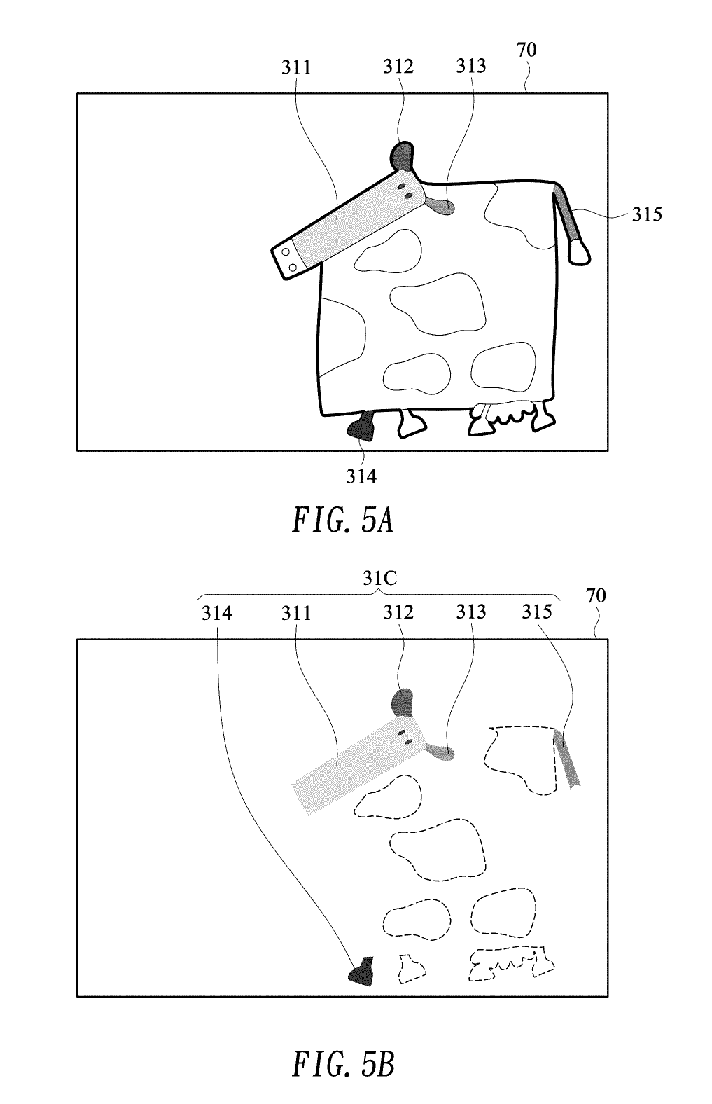

As shown in FIG. 2 and FIG. 5A, the video input module 20 is used to read a hand-drawn image 614 corresponding to the 2D character 61 of the picture book 60. The hand-drawn image 614 is a pattern located on the creative area 612 of the 2D character 61 of the picture book 60, created by kids with crayons and captured by a video camera.

The way the video input module 20 reads the hand-drawn image 614 can be using a video camera to catch real-time images or read an image file. After the hand-drawn image 614 being read, define the border 611 of the hand-drawn image 614 by software technology. The border 611 is a hand-drawn border 611.

As shown in FIG. 2 and FIG. 5B, after the hand-drawn border 611 being defined, the recognition and analysis module 30 finds out drawn content 31C inside the border 611 by the border 611. For example, the drawn content 31C includes a first creative color 311, a second creative color 312, a third creative color 313 . . . and a n^{th} creative color 31n, etc. Moreover, the drawn content 31C of other parts with dotted border in the FIG. 5B can also be found out by the above way.

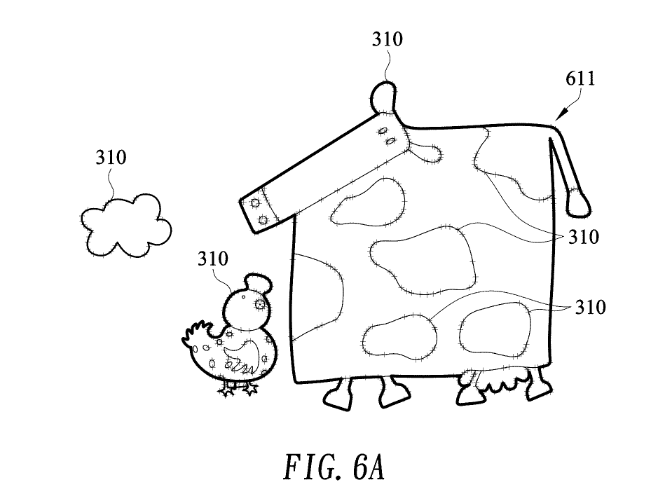

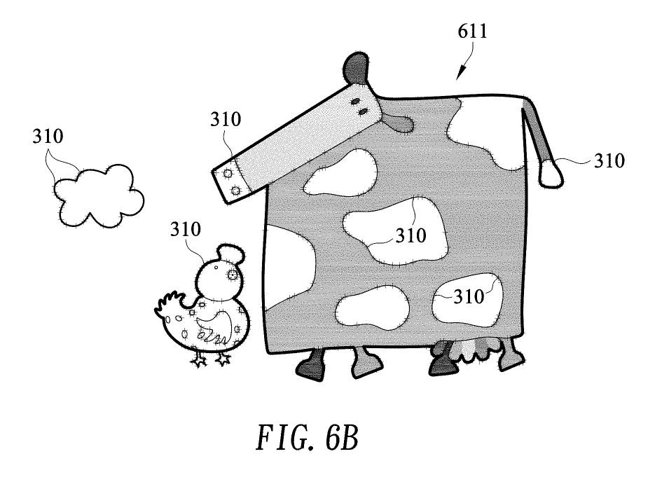

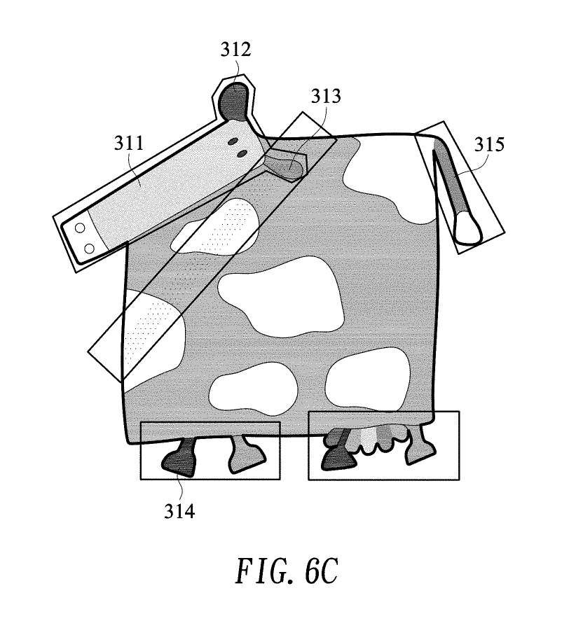

Refer to FIG. 6A and FIG. 6B, the recognition and analysis module 30 compares the drawing templates 110 with the hand-drawn border 611 so that the drawn content 31C obtained from the respective 2D character 61 corresponds to the corresponding drawing template 110 stored in the data module 10.

In order to make the comparison of the recognition and analysis module 30 more easy and convenient, a plurality of recognition points 310 is arranged at the drawing template 110 and the 2D character 61 respectively and correspondingly in advance. By the recognition point 310, the position marked “x” on the border 611 or the drawing template 110, more detailed features of the respective 2D character 61 such as head, eyes, tail, even different spots on the skin can be recognized more precisely and accurately.

As shown in FIG. 6C, the drawn content 31C are filled into the respective drawing template 110 after corresponding to the drawing templates 110. Then an AR object 33 of the 2D/3D character is generated by AR technology.

For easy operation of the system, the file name of the drawn content 31C is defined by a user account, a page number of the picture book 60, a serial number of the character of the picture book 60, an edition number being drawn, or their combinations while saving the drawn content 31C.

The voice input module 40 reads a kid's real-time speech by a PDA microphone to produce voice content 80. Moreover, the voice input module 40 can also read an audio file recorded in advance. For convenient operation of the system, the file name of the voice content 80 is defined by a user account, a page number of the picture book 60, a serial number of the character of the picture book 60, an edition number being drawn, or their combinations while saving the voice content 80.

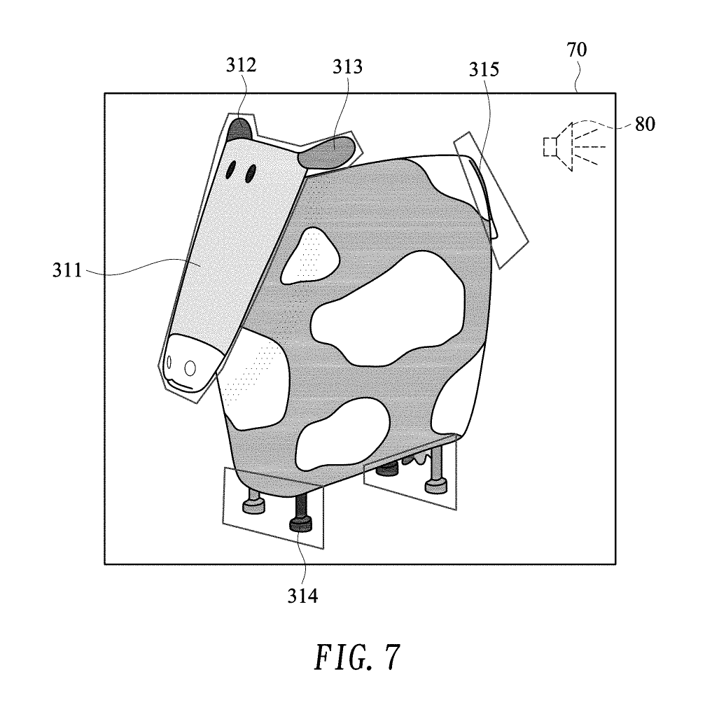

As shown in FIG. 7, the integration module 50 is used to integrate the self-created drawn content 31C recognized, the voice content 80 created, and the 2D/3D scene 120 built-in the electronic computer by using AR technology. During operation, the integration module 50 can define the respective page of the picture book 60 and create a 2D/3D model of the drawn content 31C corresponding to the respective page by AR technology. Then the 2D/3D model is applied to the 2D/3D scene 120 for providing dynamic effects and the voice content 80 is integrated with the respective page correspondingly. Thus a self-created 2D/3D AR work is produced.

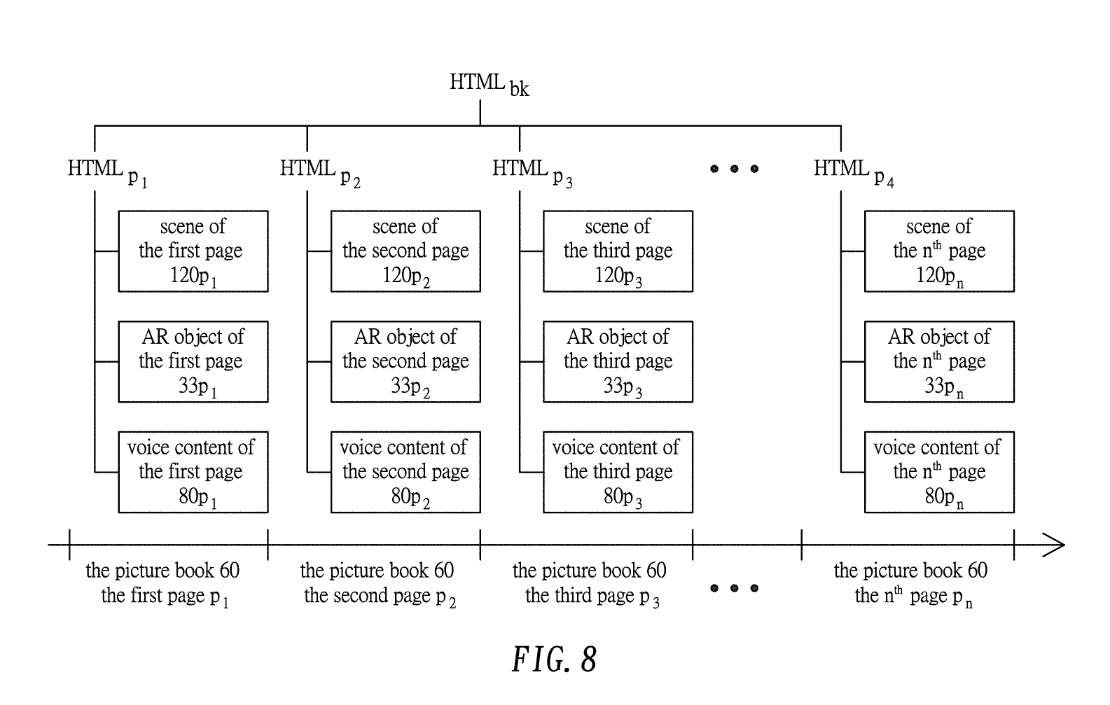

As shown in FIG. 8, a scene, a character, a speech, etc. on a page of a book is integrated by the above system to form a self-created 2D/3D AR work. During the integration process, HTML (Hypertext Markup Language) can be used to integrate the scene, the character, the speech, and so on.

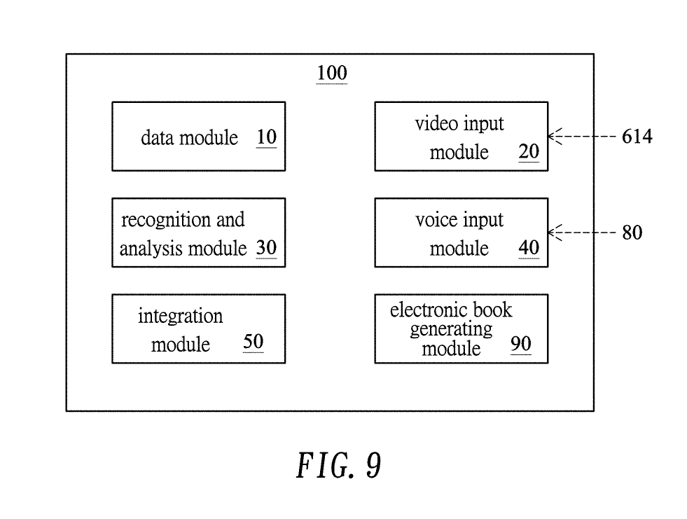

Refer to FIG. 9, another embodiment of a system that produces video works 100 according to the present invention is revealed. This embodiment further includes an electronic book generating module 90 that uses the drawn content 31C and the voice content 80 generated to construct a script for an electronic book based on the picture book 60 with multiple stories on the respective page. Then the drawn content 31C and the voice content 80 corresponding to the respective page of the electronic book script together with a plurality of components predefined as the scene are processed by AR technology to form a 2D/3D AR page of the respective page. Next these 2D/3D AR pages are connected to form a 2D/3D AR e-book with audio formats and simple page flip effect.

In other words, the electronic book generating module 90 converts each page of the picture book 60 into a HTML file. For example, the first page of the picture book 60 is converted into a HTML_{P1} file, the second page is converted into a HTML_{P2} file, the third page is converted into a HTML_{P3} file . . . and the n^{th} page is converted into a HTML_{Pn} file. Lastly all the HTML files are integrated to form an electronic book HTML_{bk}.

The respective embodiment of the system that produces video works 100 mentioned above can be a software program stored in a non-transitory computer-readable recording medium. The above system that produces video works 100 is executed when the computer reads the program of the system that produces video works 100.

The above description is only the preferred embodiments of the present invention, and is not intended to limit the present invention in any form. Although the invention has been disclosed as above in the preferred embodiments, they are not intended to limit the invention. A person skilled in the relevant art will recognize that equivalent embodiment modified and varied as equivalent changes disclosed above can be used without parting from the scope of the technical solution of the present invention. All the simple modification, equivalent changes and modifications of the above embodiments according to the material contents of the invention shall be within the scope of the technical solution of the present invention.

What is claimed is:

1. A system combining Augmented Reality (AR) technology with self-created elements to produce video works and being executed in an electronic computer system comprising:
a data module that stores at least one drawing template and at least one scene therein;
a video input module that reads a hand-drawn image corresponding to at least one 2-dimensional (2D) character of a picture book and defines a hand-drawn border of the hand-drawn image;
a recognition and analysis module that compares the drawing template with the hand-drawn border to obtain drawn content; and
an integration module that fills the drawn content into the drawing template correspondingly for generating an AR object and integrates the AR object with the scene for generating a self-created AR work.

2. The system as claimed in claim 1, wherein the scene is constructed base on a teaching aid.

3. The system as claimed in claim 1, wherein the video input module reads the hand-drawn image by using a video camera to catch a real-time image or read a hand-drawn image file.

4. The system as claimed in claim 1, wherein a file name of the drawn content is defined by an account, a page number, a serial number, an edition number, or a combination thereof.

5. The system as claimed in claim 1, wherein a plurality of recognition points is set on the drawing template and the 2D character respectively and correspondingly.

6. The system as claimed in claim 1, wherein the system further includes a voice input module that reads a real-time speech or an audio file to generate voice content; the integration module further integrates voice content, the drawn content with the scene for generating the self-created AR work.

7. The system as claimed in claim 1, wherein a file name of the voice content is defined by an account, a page number, a serial number, an edition number, or a combination thereof.

8. The system as claimed in claim 1, wherein the integration module defines the respective page of a picture book, creates a 2D or 3D model of the drawn content of the respective page, applies the 2D or 3D model to the scene for providing dynamic effects, and integrates the voice content with the respective page correspondingly to generate the self-created AR work.

9. The system as claimed in claim 1, wherein the system further includes an electronic book generating module that not only uses a book as a script and AR technology to process the drawn content, the voice content and a plurality of components predefines as the scene of the respective page to form an AR page of the respective page, but also combines the AR pages into an AR e-book with audio formats and simple page flip effect.

10. A non-transitory computer-readable medium stores the system combining Augmented Reality (AR) technology with self-created elements to produce video works as claimed in claim 1 therein.
